(19) United States
(12) Patent Application Publication
(10) Pub. No.: US 2025/0148350 A1
(43) Pub. Date: May 8, 2025

(54) DETERMINING TIME SERIES MODEL STABILITY AND ROBUSTNESS IN REFRESHMENT

(71) Applicant: International Business Machines Corporation, Armonk, NY (US)

(72) Inventors: Jiang Bo Kang, Xi'an (CN); Dong Hai Yu, Xi'an (CN); Jun Wang, Xi'an (CN); Yao Dong Liu, Xi'an (CN); Bo Song, Xi'an (CN); Xiao Ming Ma, Xi'an (CN)

(21) Appl. No.: 18/500,350

(22) Filed: Nov. 2, 2023

(51) Int. Cl. G06N 20/00

(52) U.S. Cl. CPC G06N 20/00

(57) ABSTRACT

One or more systems, devices, computer program products and/or computer-implemented methods of use provided herein relate to determining time series model stability and robustness in refreshment. The computer-implemented system can comprise a memory that can store computer executable components. The computer-implemented system can further comprise a processor that can execute the computer executable components stored in the memory, wherein the computer executable components can comprise a computation component that can employ weighted model evaluation to compute stability of time series pipelines over respective holdout datasets and a determination component that can select, based on the computed pipeline stabilities, a most stable time series pipeline.

### BACKGROUND

The subject disclosure relates to time series model selection and, more specifically, to determining time series model stability and robustness in refreshment.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable determining time series model stability and robustness in refreshment are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a computation component that can employ weighted model evaluation to compute stability of time series pipelines over respective holdout datasets. The computer executable components can further comprise a determination component that can select, based on the computed pipeline stabilities, a most stable time series pipeline.

According to another embodiment, a computer-implemented method is provided. The computer-implemented method can comprise employing, by a system operatively coupled to a processor, weighted model evaluation to compute stability of time series pipelines over respective holdout datasets. The computer-implemented method can further comprise selecting, by the system, a most stable time series pipeline based on the computed pipeline stabilities.

According to yet another embodiment, a computer program product for determining time series model stability and robustness in refreshment is provided. The computer program product can comprise a computer readable storage medium having program instructions embodied therewith, the program instructions executable by a processor to cause the processor to engage a computation component that employs weighted model evaluation to compute stability of time series pipelines over respective holdout datasets. The program instructions executable by the processor can further cause the processor to engage a determination component that, based on the computed pipeline stabilities, selects a most stable time series pipeline.

### BRIEF DESCRIPTION OF THE DRAWINGS

One or more embodiments are described below in the Detailed Description section with reference to the following drawings:

FIG. 1 illustrates a block diagram of an example, non-limiting system 100 that can facilitate determining time series model stability and robustness in refreshment in accordance with one or more embodiments described herein.

FIG. 2 illustrates a block diagram of an example, non-limiting system 200 that can facilitate determining time series model stability and robustness in refreshment in accordance with one or more embodiments described herein.

FIG. 3 illustrates an example, non-limiting plot of time series input data in accordance with one or more embodiments described herein.

FIG. 4 illustrates an example, non-limiting representation of a time series experiment in accordance with one or more embodiments described herein.

FIG. 5 illustrates an example, non-limiting plot of prediction curves for time series model evaluation in accordance with one or more embodiments described herein.

FIG. 6 illustrates an example, non-limiting representation of time series model evaluation through back testing of a pipeline in accordance with one or more embodiments described herein.

FIG. 7 illustrates an example, non-limiting representation of time series model evaluation through back testing of a pipeline in accordance with one or more embodiments described herein.

FIG. 8 illustrates an example, non-limiting representation of computed slopes and variances from back testing of a pipeline in accordance with one or more embodiments described herein.

FIG. 9 illustrates a flow diagram of an example, non-limiting method 900 of facilitating determining time series model stability and robustness in refreshment in accordance with one or more embodiments described herein.

FIG. 10 illustrates a flow diagram of an example, non-limiting method 1000 of facilitating determining time series model stability and robustness in refreshment in accordance with one or more embodiments described herein.

FIG. 11 illustrates a flow diagram of an example, non-limiting method 1100 of facilitating determining time series model stability and robustness in refreshment in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A time series is an ordered collection of measurements taken at regular intervals (e.g., stock prices, daily temperature readings, quarterly sales). Time series data typically exhibit temporal patterns, trends, and seasonality, providing insight for understanding how a particular variable changes over time. Understanding behavior and underlying structure of time series data can enable informed decision making and development of accurate predictive models. Automated Artificial Intelligence (AI) is utilized in time series model selection to leverage machine learning algorithms and automated tools to streamline and optimize the process of choosing a most appropriate model for a given time series forecasting task. Selecting an appropriate and accurate time series model involves constructing and assessing various workflows, ultimately recommending a most accurate pipeline based on evaluation performance of pipeline models using holdout datasets and back tests.

However, challenges arise regarding stability and accuracy of top selection of pipelines, as it can display variations in performance when assessed using holdout data versus real-world data after deployment. Post-deployment, adjustments can be made to a time series model based on how a selected pipeline performs in real-world applications. Time series models that are selected based on accuracy performance of historical data can experience accuracy degradation. In other words, time series models initially trained on historical data may lose accuracy as patterns change over time. If a model assumes a static underlying pattern and doesn't adapt to changing dynamics, its predictions may become increasingly inaccurate, leading to degradation in performance as time progresses. If performance of an initially selected pipeline degrades over time, updates and refinements become necessary. Selection of a model based on accuracy or runtime can cause need for adapting the model to ensure continued effectiveness over time. Particularly, in a back testing phase of time series pipelines, model evaluation is based primarily on historical holdout data to gauge a model's historical accuracy, however, such method doesn't sufficiently contribute to ensuring stability and robustness of a selected pipeline after deployment with real-world data.

Moreover, an evaluation process considers each individual time point in a holdout dataset with equal importance. Such an approach does not align with human intuition, as forecasting accuracy for near future or short-term periods is typically more prioritized than predictions for distant future or long-term periods. Assigning equal importance to all time points can introduce bias, especially when certain periods are more critical, influential, or desirable to a user (e.g., prioritizing weather forecasting of the next few days for an approaching hurricane). Neglecting such bias can lead to inaccurate model assessments and predictions.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate determining time series model stability and robustness in refreshment. That is, various disadvantages associated with existing techniques for time series model selection can be ameliorated by determining time series model stability and robustness in refreshment.

In various embodiments, a computation component can employ weighted model evaluation with weighted model evaluation metrics (e.g., weighted mean squared error, weighted mean absolute error, weighted R-squared) to perform back test evaluation over different holdout datasets. Evaluation of different holdout data at different time points can mitigate pipeline and model degradation by enabling assessment of model stability over time. Thus, a determination component can utilize a computed stability metric to select a pipeline and time series model that can provide accurate forecasting over time. Moreover, the computation component can assign weights to different time points of holdout data during back testing to reflect human intuition and prioritization of predicting data at time points closer to a current time point, enabling stable model assessments and prevent incorrect model predictions as time progresses.

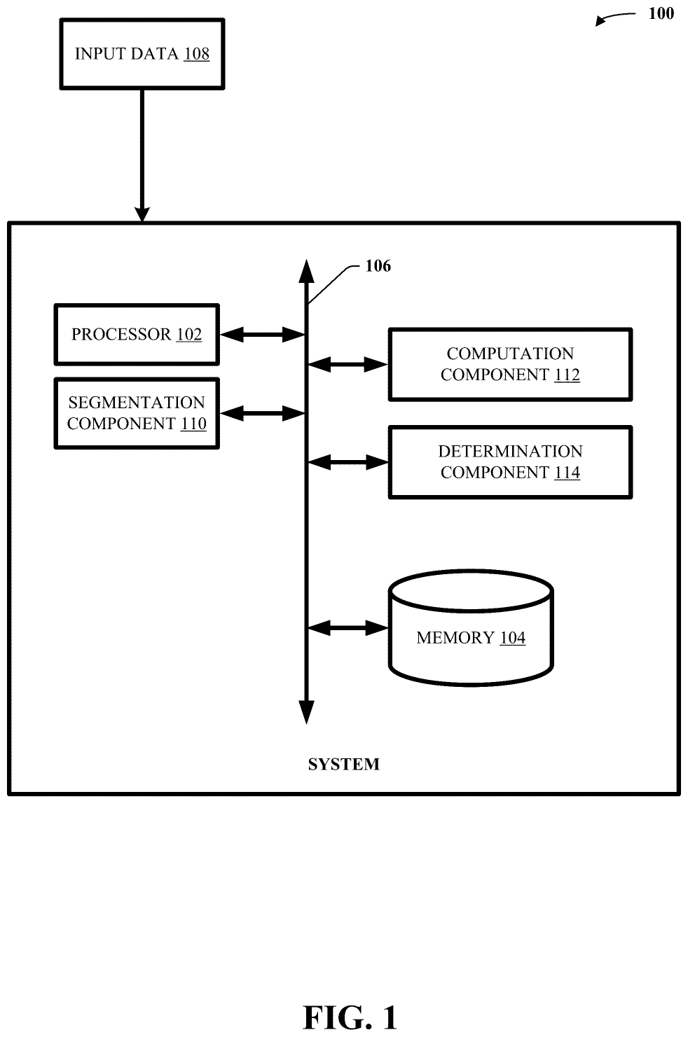

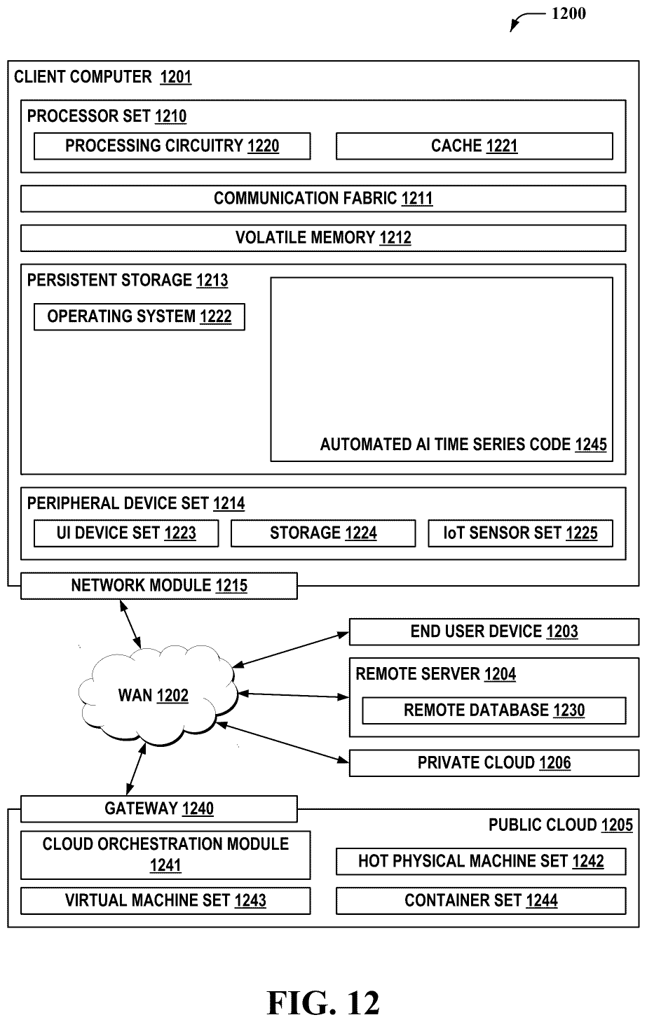

Embodiments depicted in one or more figures described herein are for illustration only, and as such, the architecture of embodiments is not limited to systems, devices and/or components depicted therein, nor to any particular order, connection and/or coupling of systems, devices and/or components depicted therein. For example, in one or more embodiments, non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1200 illustrated at FIG. 12. For example, system 100 can be associated with, such as accessible via, a computing environment 1200 described below with reference to FIG. 12, such that aspects of processing can be distributed between system 100 and the computing environment 1200. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate determining time series model stability and robustness in refreshment in accordance with one or more embodiments described herein. System 100 can comprise processor 102, memory 104, system bus 106, input data 108, segmentation component 110, computation component 112, and determination component 114.

The system 100 and/or the components of the system 100 can be employed to use hardware and/or software to solve problems that are highly technical in nature (e.g., time series modeling evaluation, time series pipeline selection, etc.), that are not abstract and that cannot be performed as a set of mental acts by a human. Further, some of the processes performed may be performed by specialized computers for carrying out defined tasks related to time series modeling and refreshment. The system 100 and/or components of the system can be employed to solve new problems that arise through advancements in technologies mentioned above and/or the like. The system 100 can provide technical improvements to time series model selection, improving time series model stability and robustness, and/or improving time series model performance, etc.

Discussion turns briefly to processor 102, memory 104, and bus 106 of system 100. For example, in one or more embodiments, system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., input data 108, segmentation component 110, computation component 112, and/or determination component 114) to perform one or more actions. In one or more embodiments, memory 104 can store computer-executable components (e.g., input data 108, segmentation component 110, computation component 112, and/or determination component 114).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, the computation component 112 can utilize a weighted model evaluation to perform back testing of time series pipelines over different holdout datasets. Based on computed model evaluation metrics from the back tests, the determination component 114 can determine the most stable pipeline for model deployment. Additional aspects of the one or more embodiments discussed herein are explained in greater detail with reference to subsequent figures. System 100 can be associated with, such as accessible via, a computing environment 1200 described below with reference to FIG. 12. For example, system 100 can be associated with a computing environment 1000 such that aspects of processing can be distributed between system 100 and the computing environment 1200.

In an embodiment, segmentation component 110 can segment input data 108 into subsets. More specifically, the segmentation component 110 can split the input data 108 into training data segments and validation data segments. The segmented training data can then be split, by the segmentation component 110, into N segments in sequential order (e.g., recent data to old data), wherein each data segment has a lookback window l. A lookback window is a parameter that denotes number of previous time series values to be used to predict the current time point. For example, in back detect 0 of segment n of the N segments, data is back tested from a time t to a time t−l. In back detect 1, the data is back tested from time t−s to time t−s−l, where s denotes the forecast step size (e.g., interval or spacing between consecutive segments to determine how the segments are positioned or spaced along the time series). As a further example, in back detect n, the data is back tested from time t−(n−1)*s to time t−(n−1)*s−l.

In various embodiments, system 100 can comprise a computation component 112. In various aspects, as described herein, the computation component 112 can employ weighted model evaluation to compute stability of time series pipelines over respective holdout datasets. In weighted model evaluation, weighted model evaluation metrics can comprise a weighted mean absolute error (WMAE), a weighted mean squared error (WMSE), and a weighted R-squared (R²), and can be formulated by the following equations respectively.

$$WMAE ( y , \hat{y} ) = \frac{1}{{n}_{samples}} {\sum }_{i = 0}^{{n}_{samples} - 1} {W}_{i} \vert {y}_{i} - {\hat{y}}_{i} \vert \qquad Equation 1$$

$$WMSE ( y , \hat{y} ) = \frac{1}{{n}_{samples}} {\sum }_{i = 0}^{{n}_{samples} - 1} {{W}_{i} ( {y}_{i} - {\hat{y}}_{i} )}^{2} \qquad Equation 2$$

$${WR}^{2} ( y , \hat{y} ) = 1 - \frac{{\sum }_{i = 0}^{n} {{W}_{i} ( {y}_{i} - {\hat{y}}_{i} )}^{2}}{{\sum }_{i = 1}^{n} {{W}_{i} ( {y}_{i} - {\overline{y}}_{i} )}^{2}} \qquad Equation 3$$

In various embodiments, the system 100 can comprise a determination component 114. In various instances, as described herein, the determination component 114 can select, based on the computed pipeline stabilities by the computation component 112, a most stable time series pipeline.

In various embodiments, the computation component 112 can utilize a predefined regressive function (e.g., linear, exponential, log) to represent relation between weight of prediction and forecast step in weighted model evaluation. The weight w can be defined by weight function w=1/g(s). For example, such link function can be defined by the following equations for a linear, exponential, or log regressive function respectively.

$$w = 1. / ( a + b * s ) \qquad Equation 4$$

$$w = 1. / ( a + b * exp ( s ) ) \qquad Equation 5$$

$$w = 1. / ( a + b * log ( s ) ) , \qquad Equation 6$$

where a denotes intercept of regressive

weight function and b is a regressive factor of forecast step. In various instances, as step s increases, weight can decrease. If b=0 and a=1, all predicted values are equally important.

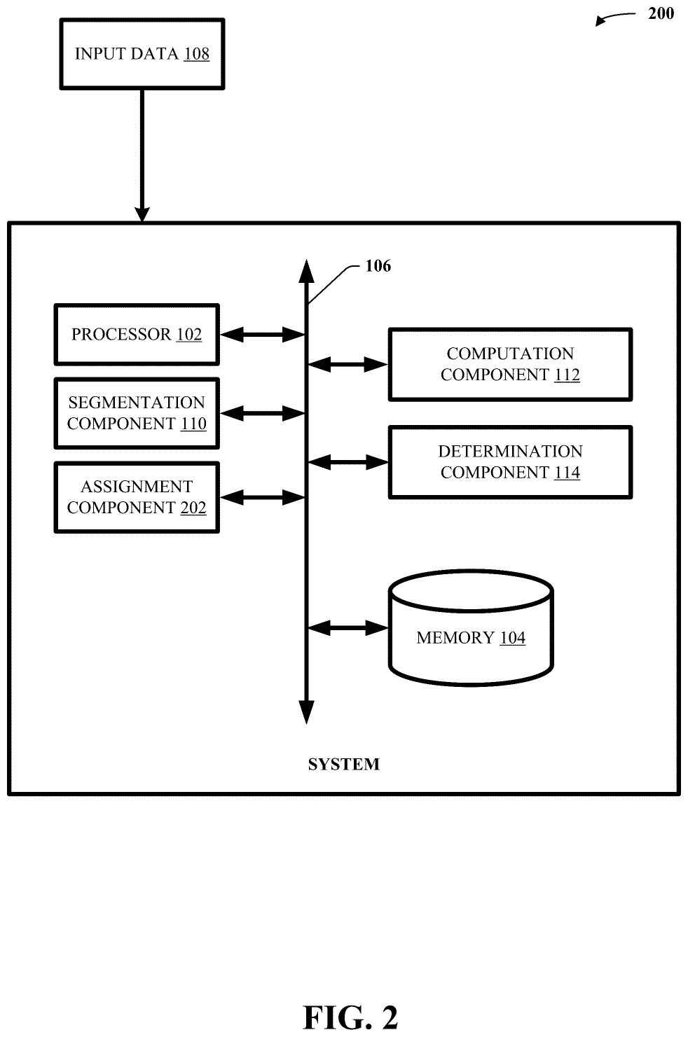

FIG. 2 illustrates a block diagram of an example, non-limiting system 200 that can facilitate determining time series model stability and robustness in refreshment in accordance with one or more embodiments described herein. As shown, system 200 can comprise, in some cases, the same components as system 100, and can further comprise an assignment component 202.

In various embodiments, the computation component 112 can engage assignment component 202 during model evaluation to assign weights to time points of holdout data based on importance of near future in weighted model evaluation. In other words, the assignment component 202 can assign unequal importance to prediction of dates defined to be close to a current time point and dates defined to be distant from the current time point to reflect prioritization of near or upcoming date forecasting. For example, input data 108 can contain 1000 dates to build a model, wherein the input data 108 can be divided by the segmentation component 110 such that first 95 dates are training data, and last 5 dates are evaluation data for evaluation of pipelines. The assignment component 202 can implement a weight for reading of future data and the allocated 5 dates for evaluation. Thus, determination component 114 can select a stable pipeline that mitigates degradation of performance over time. For example, in predicting weather, weight can be utilized to apply unequal importance of dates to reflect importance of weather predictions in upcoming days (e.g., a hurricane that is two months out, but it is desirable to know where the hurricane is moving the next week).

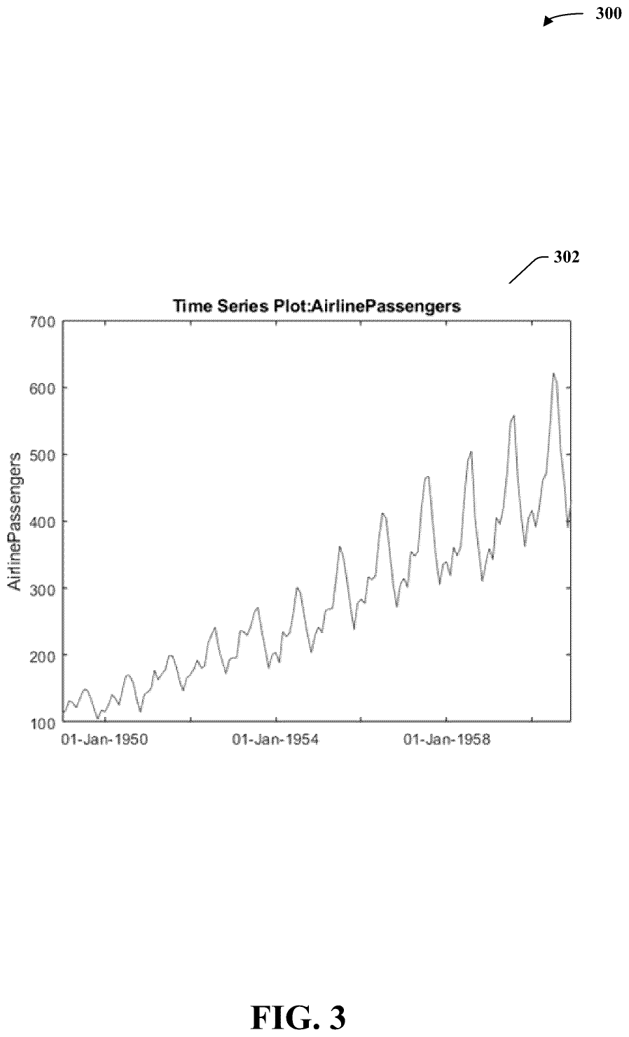

FIG. 3 illustrates an example, non-limiting plot of time series input data in accordance with one or more embodiments described herein.

In various aspects, time series can possess characteristics that can comprise trends, seasonality, or stationarity. Time series trends can be a gradual upward or downward shift in level of series or a tendency of series values to increase or decrease over time. Seasonal cycles of time series data are a repetitive, predictable pattern in the series values. Conversely, time series can be nonseasonal. That is, a nonseasonal cycle is a repetitive, possibly predictive pattern in the series values. If time series has no trend or seasonality, it is stationary. Stationarity of a time series in the time series experiment can be determined by executing an Augmented Dickey-Fuller (ADF) test by the computation component 112. The ADF test is a statistical test used to determine presence of a unit root in a time series dataset. The presence of a unit root suggests that the time series data is non-stationary. For example, in plot 302, the input data 108 contains the number of airline passengers periodically observed at regular intervals over approximately 10 years. The data is nonstationary and displays an upward trend with seasonal cycles. That is, the number of airline passengers is steadily increasing over the ten years and an increase in airline passengers can be observed periodically in cycles. For example, such seasonality of data can be explained by an increase in airline travel in summer (e.g., more airline passengers traveling for vacation in summer) and a decrease in airline travel in winter.

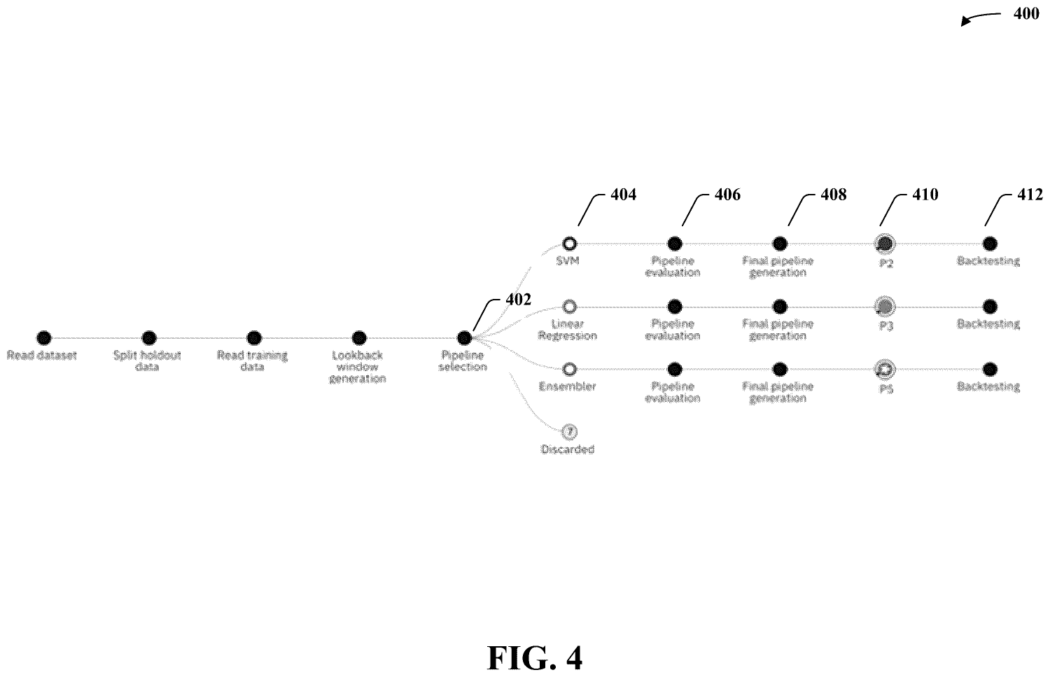

FIG. 4 illustrates an example, non-limiting representation of a time series experiment in accordance with one or more embodiments described herein.

In various aspects, after the segmentation component 110 reads the input data 108 and segments the input data 108 into training data and validation data, the determination component 114 can select a top-performing N generated pipelines and discard remaining pipelines. For example, 10 different pipelines can be built and evaluated, from which the determination component 114 can select the top 3 pipelines in a first pipeline selection 402 based on performance evaluated on holdout data following training of the pipeline on training data. A set of chosen pipelines 404, for example, can employ a support vector machine, a linear regression model, and an ensemble model. The remaining 7 pipelines that can employ other models (e.g., random forest, Autoregressive Integrated Moving Average Models (ARIMA), Holt-winters) can be discarded by the determination component 114. Of the chosen pipelines 404, each pipeline can undergo pipeline evaluation 406. In various embodiments, the pipeline evaluation 406 of each of the chosen pipelines 404 can comprise evaluation by the computation component 112 through a weighted model evaluation. In various embodiments, final pipeline generation 408 can comprise retraining each of the chosen pipelines 404 on the input data 108 to generate final pipelines 410 by the computation component 112. After final pipeline generation 408, computation component 112 can perform back testing 412 on each pipeline of the final pipelines 410.

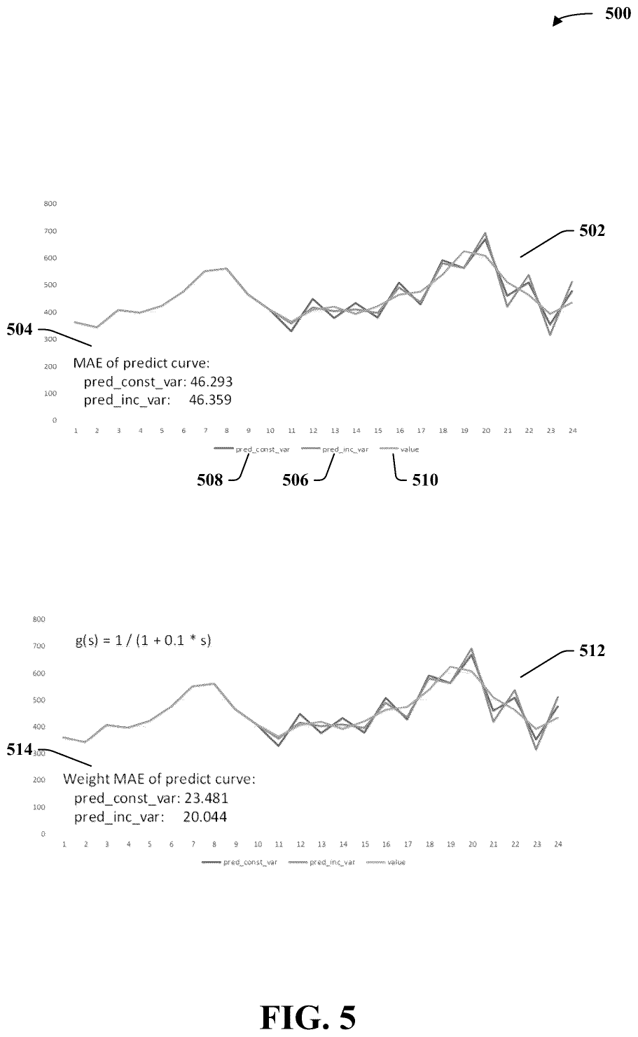

FIG. 5 illustrates an example, non-limiting plot of prediction curves for time series model evaluation in accordance with one or more embodiments described herein.

In various embodiments, plot 502 depicts a prediction curve 506 and a prediction curve 508 of an unweighted time series model evaluation over a dataset of true values. The curve 506 depicts a prediction curve with constant variance and the curve 508 depicts a prediction curve with increased variance. The curve 506 closely predicts the real data values 510 in the beginning time points and decreasingly accurately predicts the real data values 510 as time moves forward, representing accurate prediction of near future time points and inaccurate prediction of far future time points. Observed in curve 508, the prediction curve demonstrates a constant prediction accuracy as time moves forward. Furthermore, the evaluation 504 depicts the mean absolute error (MAE) of each prediction curve, wherein the MAE of both curves are similar (e.g., MAE of curve 506 is 46.359, MAE of curve 508 is 46.293). Such instances can pose challenges in selection of the final pipelines 410 because although both prediction curves demonstrate different forecasting results, both models can result in similar model quality during pipeline evaluation (e.g., MAE metrics).

In various embodiments, the plot 512 depicts two prediction curves of a weighted time series model evaluation over the dataset of true values. In various aspects, any suitable regressive weight function g(s) (e.g., linear, log, exponential) can be used in the weighted model evaluation. For example, the weighted model evaluation in plot 512 utilizes a linear regressive weight function where g(s)=1/(1+0.1*s) and s denotes the step. Utilizing a weighted model evaluation with weighted metric WMAE, the evaluation 514 demonstrates the WMAE of curve 506 (e.g., 20.044) is lower than the WMAE of curve 508 (e.g., 23.481), indicating that curve 506 (e.g., prediction with increased variance) results in better model quality than curve 508, mitigating challenges in pipeline selection (e.g., different forecasting results but similar model quality) posed by utilization of unweighted model evaluation.

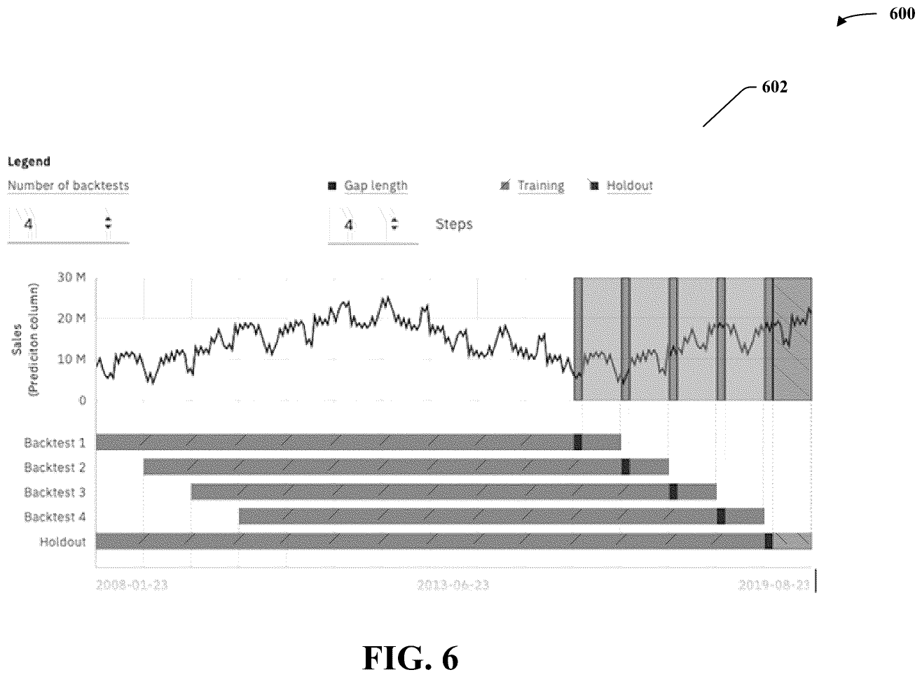

FIG. 6 illustrates an example, non-limiting representation of time series model evaluation through back testing of a pipeline in accordance with one or more embodiments described herein.

In various embodiments, back testing 412 can comprise assessing performance of time series pipelines using training data. For each of the final pipelines 410, the pipeline can be re-trained on different training datasets to assess pipeline stability and accuracy on corresponding validation datasets. For example, in graph 602, a pipeline is evaluated on 5 datasets (e.g., 4 validation datasets and 1 holdout dataset). In various embodiments, the computing component 112 can compute the average accuracy on the validation datasets in evaluation of back tests of the pipelines.

Furthermore, back testing of a pipeline can comprise utilizing different holdout datasets over different time steps s to evaluate performance of the pipeline by obtaining evaluation results over different time points. For example, if evaluation of a pipeline is consistent and similar over different time points, the determination component can determine the pipeline to be stable. Conversely, if a pipeline yields inconsistent and different evaluation results, the determination component 114 can determine the pipeline to be unstable and not a suitable pipeline for deployment. In various embodiments, back testing can also comprise a gap length, wherein the gap length is the number of time points between the training dataset and validation dataset for each back test. When the gap length value is non-zero, the time series values in the gap will not be used to train the experiment or evaluate the back test.

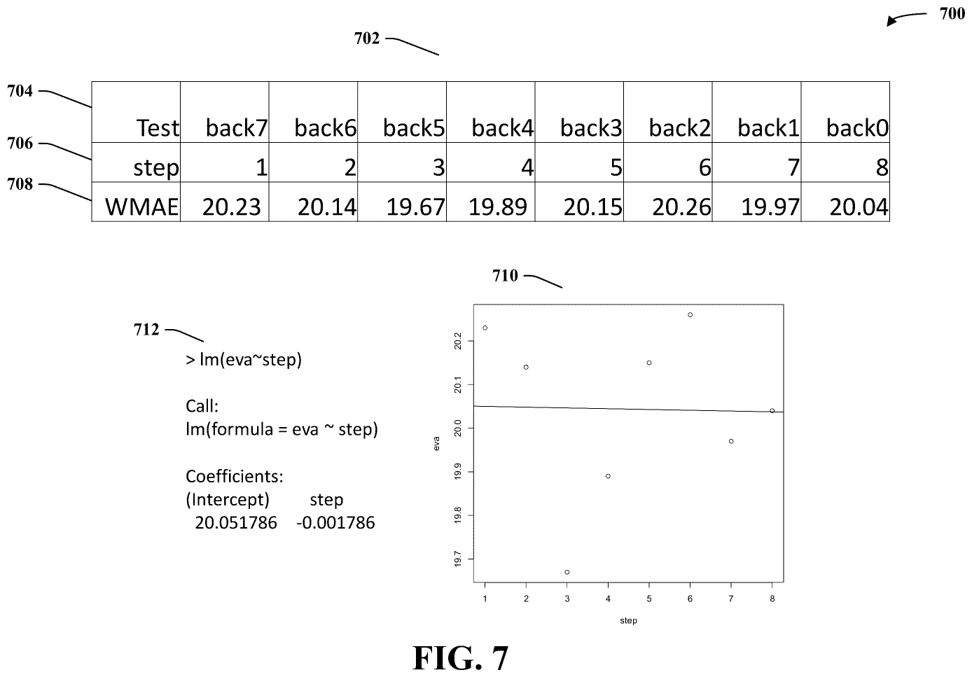

FIG. 7 illustrates an example, non-limiting representation of time series model evaluation through back testing of a pipeline in accordance with one or more embodiments described herein.

In various embodiments, the computation component 112 can use weighted model evaluation to perform back testing of a pipeline. For example, in chart 702, a weighted model evaluation can comprise eight back tests 704 over eight datasets and time steps 706 (e.g., the number of back tests increasing from old data to new data to reflect the change of model evaluation against time), resulting in eight WMAE model evaluation metrics 708. In various embodiments, the computation component 112 can perform the set of back tests 704 on each pipeline.

In various embodiments, the computation component 112 can perform a linear regression on resulting model evaluation metrics from back testing of a pipeline to compute a trend of evaluation over different holdout data. For example, plot 710 depicts eight plotted WMAE evaluation metrics 708 of a pipeline and its linear regression, where slope is denoted by a and intercept is denoted by b. In various instances, if the regression model contains a negative step regression coefficient (e.g., a downward trend or a negative slope as time moves forward), the determination component 114 can determine the model to be improving as time moves forward. Conversely, if the regression model contains a positive step regression coefficient (e.g., an upward trend or a positive slope as time moves forward), the determination component 114 can determine the model to be degrading as time moves forward. In other words, a positive slope indicates a large variance of the evaluation metric. For example, in summary statistics 712, the linear regression model of the eight WMAE evaluation metrics display a downward trend with a negative step regression coefficient (e.g., −0.001786), meaning the of the pipeline is improving as time moves forward.

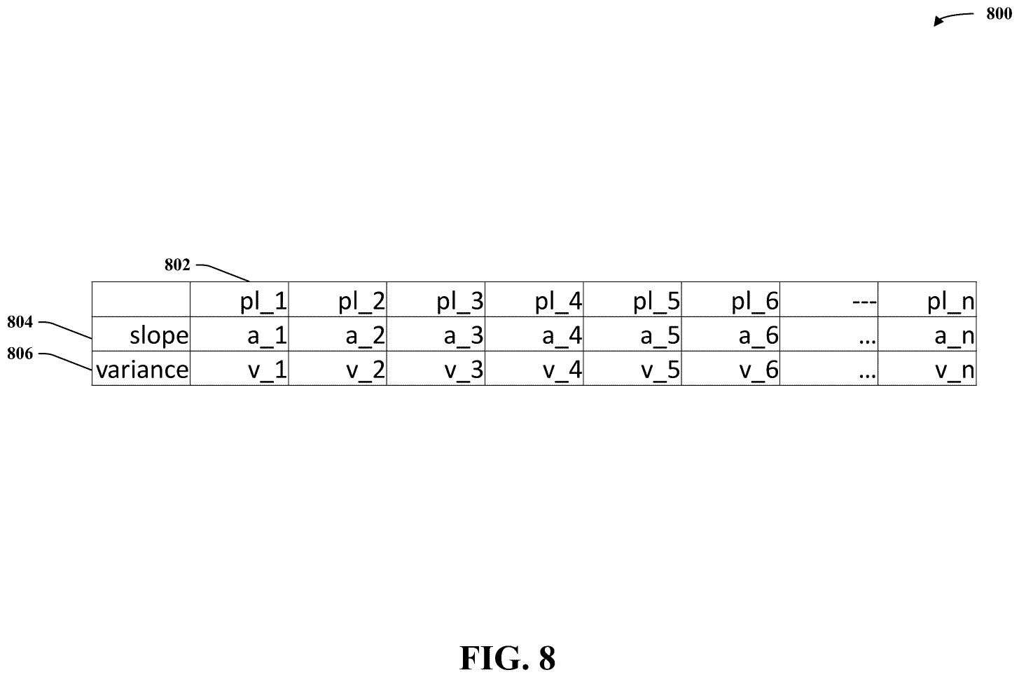

FIG. 8 illustrates an example, non-limiting representation of computed slopes and variances from back testing of a pipeline in accordance with one or more embodiments described herein.

In various embodiments, the variance of WMAE of pipeline can indicate similarity of back testing models and stability of the pipeline in model refreshment after deployment. In various aspects, the computing component 112 can calculate variance and slope of the evaluation metric WMAE for all n pipelines. For example, in chart 800, a set of pipelines 802 can include n pipelines, each with a slope 804 and a variance 806. In various embodiments, the determination component 114 can select, based on computed slopes and variances of the n pipelines, a most stable pipeline. More specifically, the determination component 114 can exclude pipelines that contain a positive slope from pipeline selection, as positive slopes indicate grading model quality as time moves forward. From the remaining pipelines, the determination component 114 can select a pipeline that has the smallest variance, as small variance indicates stability of the pipeline as time moves forward. In various aspects, if all n pipelines contain a positive slope, the determination component 114 can select a pipeline with the smallest positive slope and smallest variance.

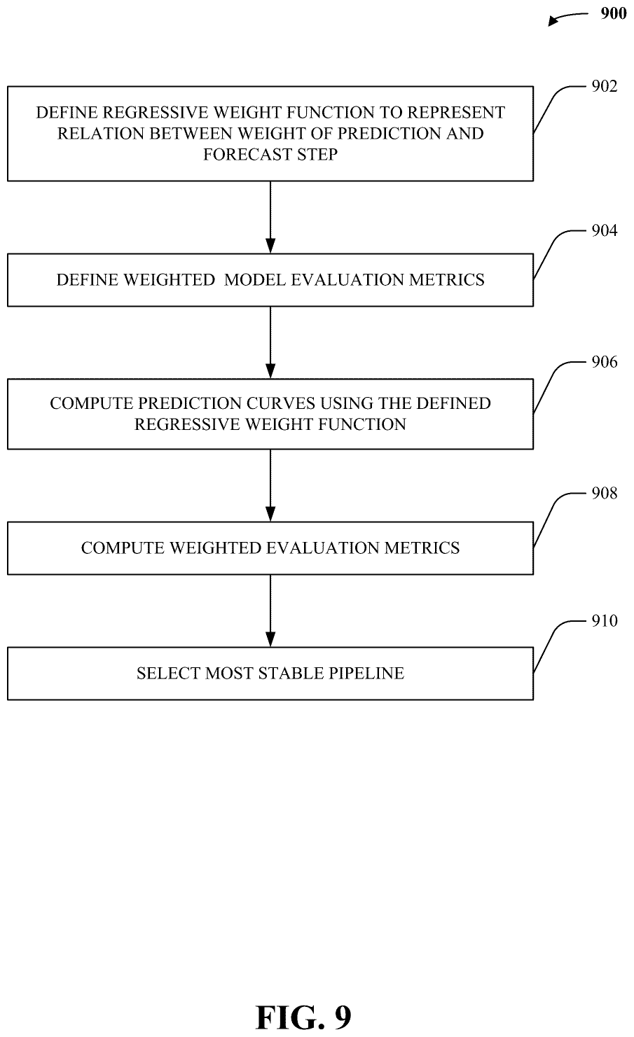

FIG. 9 illustrates a flow diagram of an example, non-limiting method 900 of facilitating determining time series model stability and robustness in refreshment in accordance with one or more embodiments described herein. Repetitive description of like elements and/or processes employed in respective embodiments is omitted for sake of brevity.

At 902, the non-limiting method 900 can comprise defining (e.g., by the computation component 112), by the system, a regressive weight function to represent a relation between weight of prediction and forecast step.

At 904, the non-limiting method 900 can comprise defining (e.g., by the computation component 112), by the system, weighted model evaluation metrics.

At 906, the non-limiting method 900 can comprise computing (e.g., by the computation component 112), by the system, prediction curves using the defined regressive weight function.

At 908, the non-limiting method 900 can comprise computing (e.g., by the computation component 112), by the system, model evaluation metrics.

At 910, the non-limiting method 900 can comprise selecting (e.g., by the determination component 114), by the system, a most stable pipeline.

For example, an exponential regressive weight function can be defined to represent the relation between the weight of prediction and the forecast step. Furthermore, weighted model evaluation metrics can be defined to include WMSE, WMAE, and R². Given the defined exponential regressive weight function, a prediction curve can be computed to evaluate the performance of various time series models. Moreover, the computation component 112 can compute the defined weighted model evaluation metrics. Thus, the determination component 114 can utilize the computed metrics to evaluate the stability of the pipeline and select a most stable pipeline that has a nonpositive slope and a minimum variance in a linear regression of the evaluation metrics.

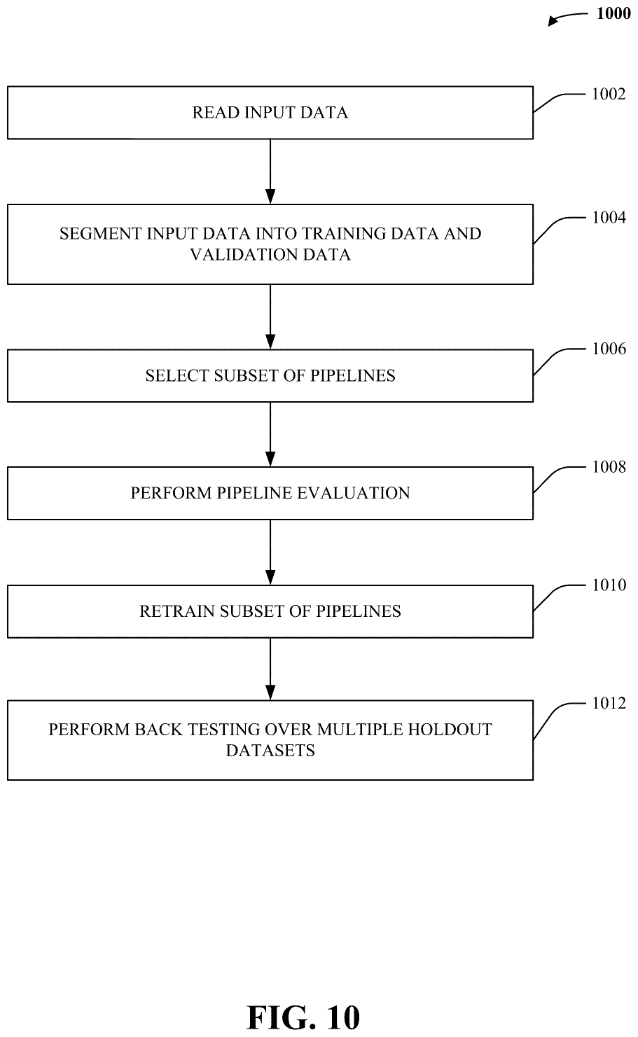

FIG. 10 illustrates a flow diagram of an example, non-limiting method 1000 of facilitating determining time series model stability and robustness in refreshment in accordance with one or more embodiments described herein. Repetitive description of like elements and/or processes employed in respective embodiments is omitted for sake of brevity.

At 1002, the non-limiting method 1000 can comprise reading (e.g., by the segmentation component 110), by the system, the input data 108.

At 1004, the non-limiting method 1000 can comprise segmenting (e.g., by the segmentation component 110), by the system, the input data 108 into training data and validation data.

At 1006 the non-limiting method 1000 can comprise selecting (e.g., by the determination component 114), by the system, a subset of pipelines.

At 1008, the non-limiting method 1000 can comprise performing (e.g., by the computation component 112), by the system, pipeline evaluation.

At 1010, the non-limiting method 1000 can comprise retraining (e.g., by the computation component 112), by the system, the subset of pipelines on the input data 108.

At 1012, the non-limiting method 1000 can comprise performing (e.g., by the computation component 112), by the system, over multiple holdout datasets on the subset of pipelines.

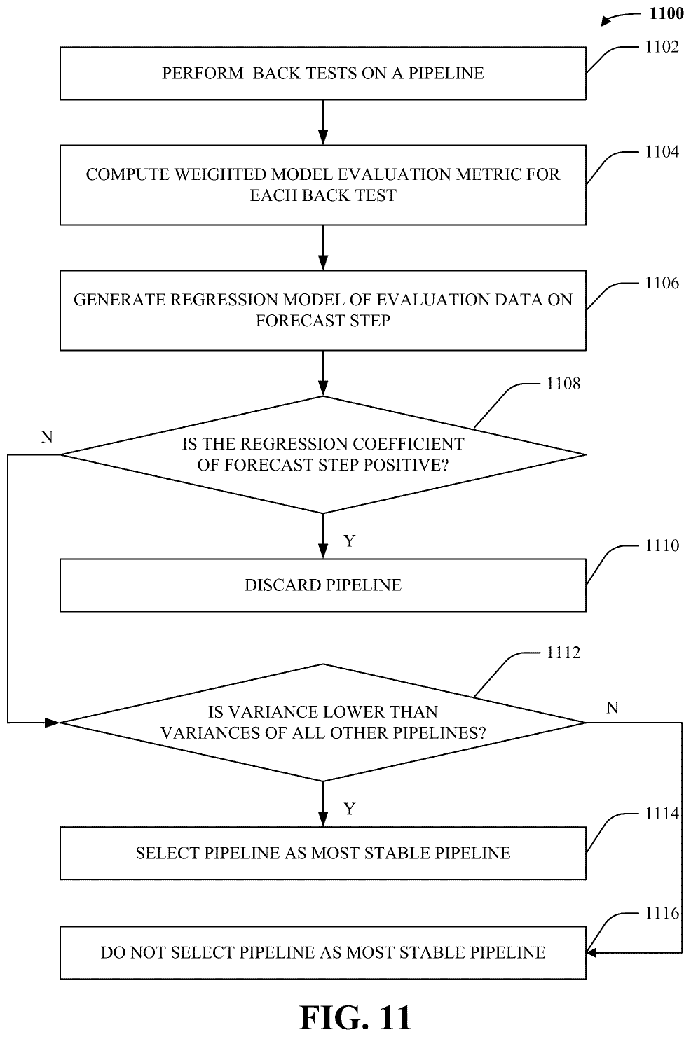

FIG. 11 illustrates a flow diagram of an example, non-limiting method 1100 of facilitating determining time series model stability and robustness in refreshment in accordance with one or more embodiments described herein. Repetitive description of like elements and/or processes employed in respective embodiments is omitted for sake of brevity.

At 1102, the non-limiting method 1100 can comprise performing (e.g., by the computation component 112), by the system, back tests on a pipeline.

At 1104, the non-limiting method 1100 can comprise computing (e.g., by the computation component 112), by the system, weighted model evaluation metrics for each back test.

At 1106, the non-limiting method 1100 can comprise generating (e.g., by the computation component 112), by the system, a regression model of evaluation data on forecast step.

At 1108, the non-limiting method 1100 can determine if the regression coefficient of forecast step is positive. If yes, the non-limiting method 1100 can discard, at 1114, the pipeline. If no, the non-limiting method 1100 can proceed to 1116.

At 1112, the non-limiting method 1100 can determine if the variance of the pipeline is lower than the variances of all other pipelines. If yes, the non-limiting method 1100 can select, at 1114, the pipeline as the most stable pipeline. If no, the non-limiting method 1100 can proceed to 1110.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively determine time series model stability and robustness in refreshment as the one or more embodiments described herein can enable this process. And, neither can the human mind nor a human with pen and paper determine time series model stability and robustness in refreshment, as conducted by one or more embodiments described herein.

FIG. 12 illustrates a block diagram of an example, non-limiting, operating environment in which one or more embodiments described herein can be facilitated. FIG. 12 and the following discussion are intended to provide a general description of a suitable operating environment 1200 in which one or more embodiments described herein at FIGS. 1-11 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as automated AI time series code 1245. In addition to block 1245, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1245, as identified above), peripheral device set 1214 (including user interface (UI), device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1245 in persistent storage 1213.

COMMUNICATION FABRIC 1211 is the signal conduction paths that allow the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, the volatile memory is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open source Portable Operating System Interface type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the afore described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, the computer-executable components comprising:
a computation component that employs weighted model evaluation to compute stability of time series pipelines over respective holdout datasets; and
a determination component that, based on the computed pipeline stabilities, selects a most stable time series pipeline.

2. The system of claim 1, wherein the system further comprises an assignment component that assigns weights to time points of holdout data based on importance of near future over far future.

3. The system of claim 1, wherein each pipeline is re-trained on a multiplicity of training data sets and wherein the computation component computes corresponding accuracies of validation datasets.

4. The system of claim 3, wherein the determination component utilizes average of computed accuracies of the validation data for final back testing pipeline evaluation.

5. The system of claim 1, wherein the computation component employs a linear regressive weight function on evaluation data to predict curve and evaluation metrics of the weighted model evaluation.

6. The system of claim 1, wherein the computation component employs a set of predefined regressive functions to represent relation between weight of prediction and weight of forecast of the weighted model evaluation.

7. The system of claim 1, wherein the computation component employs evaluation data to build a linear regression model to determine trend of evaluation with different testing datasets.

8. The system of claim 1, wherein the computation component computes variance of weighted mean absolute error to indicate similarity of back testing models and reflect stability in pipeline refreshment after deployment.

9. The system of claim 1, wherein the determination component selects a pipeline based on a determination that the pipeline does not have a positive slope and has smallest variance for back testing.

10. A computer-implemented method, comprising:
employing, by the system, weighted model evaluation to compute stability of time series pipelines over respective holdout datasets; and
selecting, by the system, a most stable time series pipeline based on the computed pipeline stabilities.

11. The computer-implemented method of claim 10, further comprising engaging an assignment component that assigns weights to time points of holdout data based on importance of near future over far future.

12. The computer-implemented method of claim 10, further comprising re-training each pipeline on a multiplicity of training data sets and engaging a computing component to compute corresponding accuracies of validation datasets.

13. The computer-implemented method of claim 12, further comprising engaging a determination component to utilize average of computed accuracies of the validation data for final back testing pipeline evaluation.

14. The computer-implemented method of claim 10, further comprising engaging the computation component to employ a set of predefined regressive functions to represent relation between weight of prediction and weight of forecast of the weighted model evaluation.

15. The computer-implemented method of claim 10, further comprising engaging the computation component to employ a linear regressive weight function on evaluation data to predict curve and evaluation metrics of the weighted model evaluation.

16. The computer-implemented method of claim 10, further comprising engaging the computation component to employ evaluation data to build a linear regression model to determine trend of evaluation with different testing datasets.

17. The computer-implemented method of claim 10, further comprising engaging the computation component to compute variance of weighted mean absolute error (WMAE) to indicate similarity of back testing models and reflect stability in pipeline refreshment after deployment.

18. The computer-implemented method of claim 10, further comprising engaging the determination component to select a pipeline based on a determination that the pipeline does not have a positive slope and has smallest variance for back testing.

19. A computer program product comprising a non-transitory computer-readable memory having program instructions embodied therewith, the program instructions executable by a processor to cause the processor to:
engage a computation component that employs weighted model evaluation to compute stability of time series pipelines over respective holdout datasets; and
engage a determination component that, based on the computed pipeline stabilities, selects a most stable time series pipeline.

20. The computer program product of claim 19, wherein the program instructions are further executable to cause the processor to:
engage an assignment component that assigns weights to time points of holdout data based on importance of near future over far future.
